(19) United States
(12) Patent Application Publication
(10) Pub. No.: US 2025/0371756 A1
(43) Pub. Date: Dec. 4, 2025

(54) TRAINED MODEL GENERATION DEVICE, INFORMATION PROCESSING DEVICE, TRAINED MODEL GENERATION METHOD, INFORMATION PROCESSING METHOD, RECORDING MEDIUM IN WHICH TRAINED MODEL GENERATION PROGRAM IS RECORDED, AND RECORDING MEDIUM IN WHICH INFORMATION PROCESSING PROGRAM IS RECORDED

(71) Applicants: General Incorporated Association Wellness Meister Association, Tokyo (JP); M.M.E. Co., Ltd., Yamaguchi (JP); IoYou Inc., Yamaguchi (JP)

(72) Inventors: Masaru SUZUKI, Yamaguchi (JP); Yukihisa NAMIKI, Yamaguchi (JP); Mitsuo NUMATA, Yamaguchi (JP); Kazuyoshi HATA, Tokyo (JP); Masashi TAKEMOTO, Tokyo (JP)

(21) Appl. No.: 19/222,766

(22) Filed: May 29, 2025

(30) Foreign Application Priority Data
May 31, 2024 (JP) 2024-089436

(51) Int. Cl. G06T 11/00; G06T 5/60; G06T 7/90

(52) U.S. Cl. CPC G06T 11/001; G06T 5/60; G06T 7/90; G06T 2207/10024; G06T 2207/20081

(57) ABSTRACT

An information processing device acquires a learning image in which a subject for learning and a color chart appear. The information processing device calculates a correction coefficient for correcting a color appearing in the color chart in the learning image to a reference color as a reference. The information processing device generates learning data in which an image of a portion of the subject for learning in the learning image is associated with the correction coefficient. The information processing device generates a trained model that outputs a correction coefficient for correcting a color of an image in which a subject appears in response to an input of the image based on the learning data.

### CROSS-REFERENCE TO RELATED APPLICATION

This application is based on and claims priority under 35 USC 119 from Japanese Patent Application No. 2024-089436 filed on May 31, 2024, the disclosure of which is incorporated by reference herein.

### BACKGROUND

### Technical Field

A technique of the present disclosure relates to a trained model generation device, an information processing device, a trained model generation method, an information processing method, a recording medium in which a trained model generation program is recorded, and a recording medium in which an information processing program is recorded.

### Related Art

Chinese Patent Application Publication No. 115482160 discloses a tongue color correction method based on a deep neural network. Specifically, Chinese Patent Application Publication No. 115482160 discloses a technique for solving color deviation generated by a tongue image of a mobile device and color distortion of the tongue image using the deep neural network.

The technique disclosed in Chinese Patent Application Publication No. 115482160 is a technique for performing color correction of a tongue using the deep neural network. As disclosed in Chinese Patent Application Publication No. 115482160, a color of an image obtained by capturing an image of a subject is greatly affected by an illumination environment during the image capturing. Therefore, there is a problem that the color of the subject appearing in the image is different from an original color, and it is difficult to perform analysis using information regarding the original color of the subject. Therefore, a method of restoring the color of the subject appearing in the image to the original color using a color chart as reference information during the image capturing and performing color correction on the subject based on the reference information is generally adopted.

In the conventional method using the color chart, it is necessary to capture an image of the color chart together with the subject. Specifically, the color of the subject appearing in the image is corrected by acquiring an image in which the subject and the color chart appear and executing processing of transforming a color of the color chart in the image into a reference color as a reference.

However, in the case of using the conventional method, it is necessary to capture the image of the color chart at the same time every time the image of the subject is captured, and there is a problem of complexity.

A technique of the disclosure has been made in view of the above circumstances, and provides a trained model generation device, an information processing device, a trained model generation method, an information processing method, a recording medium in which a trained model generation program is recorded, and a recording medium in which an information processing program is recorded which are capable of executing color correction, similar to a color correction method using a color chart, on a subject without capturing an image of the color chart together with the subject.

### SUMMARY

In order to achieve the above object, a first aspect of the disclosure is a trained model generation device including: a learning acquisition unit that acquires a learning image in which a subject for learning and a color chart appear; a calculation unit that calculates a correction coefficient for correcting a color appearing in the color chart in the learning image to a reference color as a reference; a learning data generation unit that generates learning data in which an image of a portion of the subject for learning in the learning image is associated with the correction coefficient; and a trained model generation unit that generates a trained model that outputs a correction coefficient for correcting a color of an image in which a subject appears in response to an input of the image based on the learning data.

A second aspect of the disclosure is a trained model generation method causing a computer to execute processing, the processing including: acquiring a learning image in which a subject for learning and a color chart appear; calculating a correction coefficient for correcting a color appearing in the color chart in the learning image to a reference color as a reference; generating learning data in which an image of a portion of the subject for learning in the learning image is associated with the correction coefficient; and generating a trained model that outputs a correction coefficient for correcting a color of an image in which a subject appears in response to an input of the image based on the learning data.

A third aspect of the disclosure is a recording medium in which a trained model generation program for causing a computer to execute processing is recorded, the processing including: acquiring a learning image in which a subject for learning and a color chart appear; calculating a correction coefficient for correcting a color appearing in the color chart in the learning image to a reference color as a reference; generating learning data in which an image of a subject portion for learning in the learning image and the correction coefficient are associated with each other; and generating, based on the learning data, a trained model in which a correction coefficient for correcting a color of the image when the image in which the subject appears is input is output.

A fourth aspect of the disclosure is an information processing device including: an acquisition unit that acquires an image in which a subject appears as a target; and a correction unit that inputs the image acquired by the acquisition unit to a trained model generated in advance to acquire a correction coefficient output from the trained model and correct a color of the image using the correction coefficient, wherein the trained model is a trained model that outputs a correction coefficient for correcting a color of an image in which a subject appears in response to an input of the image, the trained model being trained in advance based on learning data in which a subject for learning is associated with the correction coefficient for learning, and the correction coefficient for learning is a correction coefficient for correcting a color appearing in a color chart in a learning image in which a subject for learning and the color chart appear to a reference color as a reference.

A fifth aspect of the disclosure is an information processing method that causes a computer to execute processing, the processing including: acquiring an image in which a subject appears as a target; and inputting the acquired image to a trained model generated in advance to acquire a correction coefficient output from the trained model and correct a color of the image using the correction coefficient, wherein the trained model is a trained model that outputs a correction coefficient for correcting a color of an image in which a subject appears in response to an input of the image, the trained model being trained in advance based on learning data in which a subject for learning is associated with the correction coefficient for learning, and the correction coefficient for learning is a correction coefficient for correcting a color appearing in a color chart in a learning image in which a subject for learning and the color chart appear to a reference color as a reference.

A sixth aspect of the disclosure is a recording medium in which an information processing program for causing a computer to execute processing is recorded, the processing including: acquiring an image in which a subject appears as a target; and inputting the acquired image to a trained model generated in advance to acquire a correction coefficient output from the trained model and correct a color of the image using the correction coefficient, wherein the trained model is a trained model that outputs a correction coefficient for correcting a color of an image in which a subject appears in response to an input of the image, the trained model being trained in advance based on learning data in which a subject for learning is associated with the correction coefficient for learning, and the correction coefficient for learning is a correction coefficient for correcting a color appearing in a color chart in a learning image in which a subject for learning and the color chart appear to a reference color as a reference.

According to the technique of the disclosure, it is possible to obtain an effect that the color correction similar to the color correction method using the color chart can be executed on the subject without capturing the image of the color chart together with the subject.

### BRIEF DESCRIPTION OF THE DRAWINGS

FIG. 1 is a diagram illustrating an example of a schematic configuration of an information processing device of an embodiment;

FIG. 2 is a view for describing color correction using a color chart;

FIG. 3 is a view for describing an increase in learning data;

FIG. 4 is a view for describing a trained model of the embodiment;

FIG. 5 is a diagram illustrating an example of a computer included in the information processing device;

FIG. 6 is a view illustrating an example of trained model generation processing executed by the information processing device of the embodiment; and

FIG. 7 is a view illustrating an example of information processing executed by the information processing device of the embodiment.

### DETAILED DESCRIPTION

Hereinafter, embodiments of a technique of the disclosure will be described in detail with reference to the drawings.

### <Information Processing Device of Embodiment>

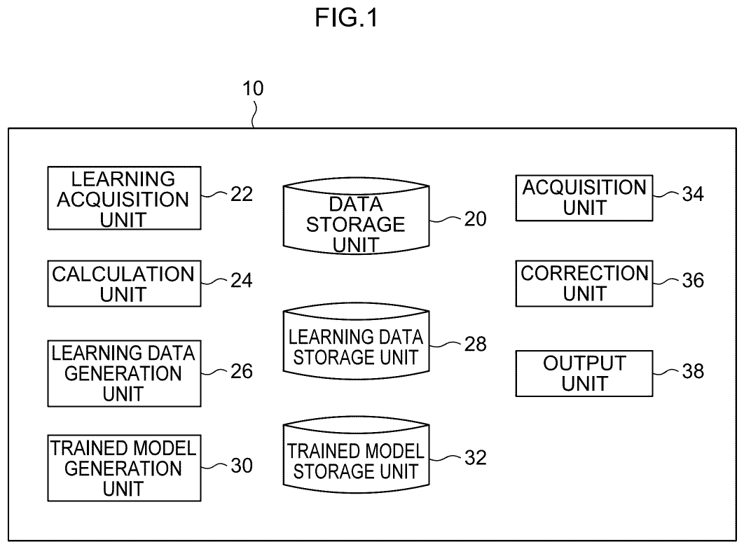

FIG. 1 illustrates an information processing device 10 according to an embodiment. As illustrated in FIG. 1, the information processing device 10 functionally includes a data storage unit 20, a learning acquisition unit 22, a calculation unit 24, a learning data generation unit 26, a learning data storage unit 28, a trained model generation unit 30, a trained model storage unit 32, an acquisition unit 34, a correction unit 36, and an output unit 38. The information processing device 10 is implemented by a computer as described later.

It is assumed that there are various light environments when an image of a subject is captured. Therefore, in order to grasp a true color of the subject, it is necessary to correct a color of the image in which the subject is captured. As a method of correcting the color of the image, a color correction method using a color chart is known.

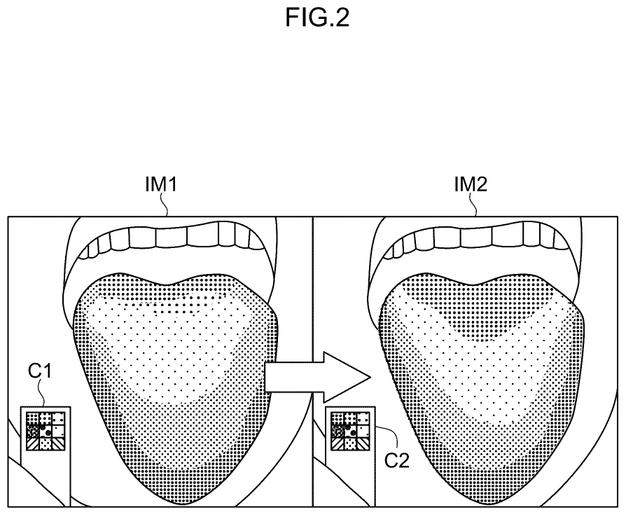

FIG. 2 is a view for describing color correction using a color chart. In the present embodiment, the case of correcting a color of an image in which a tongue that is an example of the subject appears is considered. In the case of correcting a color of an image using the color chart, an image of a color chart C1 is also captured when an image IM1 of the tongue is captured as illustrated in FIG. 2. Then, a color of the image IM1 is corrected using a correction coefficient by which a color of the color chart C1 appearing in the image IM1 is transformed into a reference color as a reference. Specifically, an image after the color correction is indicated by IM2 illustrated in FIG. 2, and a color of a color chart C2 in the image IM2 is the reference color.

However, a method of simultaneously capturing the image of the subject and the color chart has a problem of complexity as described above. Therefore, the information processing device 10 of the present embodiment acquires the correction coefficient for color correction of an image using a machine learning model. Hereinafter, description will be given in detail.

The data storage unit 20 stores a plurality of learning images in which a tongue, which is a subject for learning, and a color chart appear. Hereinafter, the learning image is referred to as a first learning image.

The learning acquisition unit 22 reads a plurality of first learning images stored in the data storage unit 20 to acquire the plurality of first learning images.

The calculation unit 24 calculates a correction coefficient for correcting a color appearing in the color chart in the first learning image to a reference color as a reference using a known method.

Specifically, first, the calculation unit 24 extracts a color chart region from the first learning image using a known image processing method. For example, the calculation unit 24 extracts the color chart region from the first learning image using a trained model for color chart extraction that outputs 1 for a color chart region and outputs 0 for a region different from the color chart region with respect to an input image. The trained model for color chart extraction can be constructed by a known machine learning technique.

Next, the calculation unit 24 separates each of panels (a plurality of rectangular regions illustrated in FIG. 2) in the color chart using a known image processing method. The calculation unit 24 uses a known method to calculate a correction coefficient for transforming a color of each of the panels in the color chart into a reference color as a reference.

For example, a case in which a color c=(R, G, B) in an image is corrected to a reference color c′=(R′, G′, B′) as a reference will be considered. Note that each of R, G, and B corresponds to, for example, a pixel value of 0 to 255. In this case, the color c can be corrected to the reference color c′ by the following linear transformation formula (1).

$${c}^{′} = Wc + b \qquad ( 1 )$$

In the above Formula (1), W is a matrix, and b is a vector. In the present embodiment, a correction coefficient vector w obtained by combining each component of the matrix W and each component of b is defined as follows. Note that the following correction coefficient vector w corresponds to one point in a correction coefficient vector space. As illustrated below, the correction coefficient vector space is a 12-dimensional space since the correction coefficient vector is a 12-dimensional vector.

$$w ≡ [ {w}_{11} , {w}_{12} , {w}_{13} , {w}_{21} , {w}_{22} , {w}_{23} , {w}_{31} , {w}_{32} , {w}_{33} , {b}_{1} , {b}_{2} , {b}_{3} ]$$

In the case of correcting the color c of each pixel in the image to the reference color c′ using the correction coefficient vector w having a large number of components as described above (the number of components is 12), there may be a case in which the color c is corrected to a color different from the actual reference color due to a large number of variables. Therefore, in the present embodiment, an encoding correction coefficient vector w′ described below is generated by reducing the dimensions of the correction coefficient vector w in order to improve the accuracy of color correction. Note that the encoding correction coefficient vector w′ corresponds to one point in an encoding correction coefficient vector space. The encoding correction coefficient vector space is a 5-dimensional space.

$${w}^{′} ≡ [ {w}_{1}^{′} , {w}_{2}^{′} , {w}_{3}^{′} , {w}_{4}^{′} , {w}_{5}^{′} ]$$

When the correction coefficient vector w is transformed into the encoding correction coefficient vector w′, a transformation function is used to reduce an error between a correction coefficient vector w^{c} obtained when the encoding correction coefficient vector w′ is retransformed into the correction coefficient vector w and the original correction coefficient vector w. Examples of the transformation function include principal component analysis or an auto-encoder neural network as described later. Although a case in which the transformation function is principal component analysis or an auto-encoder neural network will be described as an example hereinafter, the invention is not limited thereto, and any transformation function may be used as long as a transformation from the correction coefficient vector w to the encoding correction coefficient vector w′ is appropriately executed by the transformation function.

For example, a case in which principal component analysis is used as the above-described transform function will be considered. In this case, the principal component analysis is executed on a distribution of the plurality of correction coefficient vectors w corresponding to a group of images with color charts collected in advance. The encoding correction coefficient vector w′ corresponding to the original correction coefficient vector w is calculated by executing an operation of w′=Uw based on a transformation matrix U in which eigenvectors of a major principal component axis obtained by the principal component analysis are arranged.

Alternatively, an existing auto-encoder neural network may be used as the above-described transformation function. The auto-encoder neural network includes two layers of an encoding layer that transforms an input into a lower-dimensional vector and a decoding layer that decodes the input into an original dimension. In this case, when the correction coefficient vector w is input to the auto-encoder neural network trained to maximize the accuracy of decoding for the entire learning image group, the encoding correction coefficient vector w′ is obtained from the encoding layer of the auto-encoder neural network.

Note that the above-described 5-dimensional encoding correction coefficient vector w′ is an example, and the number of dimensions may be adjusted depending on a color distribution of a group of target images.

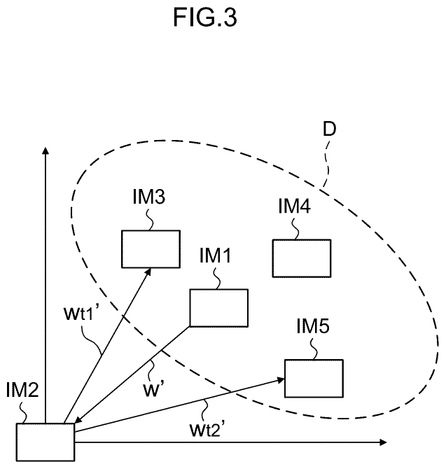

In addition, the learning data generation unit 26 increases learning data. FIG. 3 is a view for describing the increase in the learning data. The coordinate space in FIG. 3 represents a color space.

As illustrated in FIG. 3, the learning data generation unit 26 corrects a color of the image IM1, which is the first learning image, using the above-described encoding correction coefficient vector w′ to generate the corrected image IM2. As illustrated in FIG. 3, the color c of the first learning image IM1 is corrected to the reference color c′ by allocating each component of the encoding correction coefficient vector w′ to each component of the matrix W and each component of the vector b of the above Formula (1) and then calculating the above Formula (1), whereby the corrected image IM2 is generated.

More specifically, first, according to the above Formula (1), the correction coefficient vector w that minimizes an error between the color c′ and the reference color c is calculated for all the panels in the color chart appearing in the image IM1 that is the first learning image. Next, as described above, the encoding correction coefficient vector w′ corresponding to the correction coefficient vector w is calculated by the transformation function such as the principal component analysis or the auto-encoder neural network. As illustrated in FIG. 3, the transformation processing illustrated in the above Formula (1) is executed using the encoding correction coefficient vector w′, whereby the color c of the first learning image IM1 is corrected to the reference color c′, and the corrected image IM2 is generated.

Next, the learning data generation unit 26 changes the color of the corrected image IM2 to generate a plurality of second learning images IM3, IM4, and IM5. At this time, the learning data generation unit 26 generates the plurality of second learning images so as to fall within a distribution range of each pixel value of the plurality of first learning images.

Specifically, the encoding correction coefficient vector w′ illustrated in FIG. 3 is changed by a random number to generate a plurality of teacher transformation vectors wₜⁱ′. An index for identifying a teacher transformation vector is indicated by i. Next, each component of the teacher transformation vector wₜⁱ′ is assigned to each component of the matrix W and each component of b in the above Formula (1). Then, a color conversion is executed on the corrected image IM2 according to the following Formula (2). The reference color c′, which is the color of the corrected image IM2, is transformed into the color c by the following Formula (2). The color c corresponds to a color of an image obtained in an actual light environment, and is also a pseudo color.

$$c = {W}^{- 1} ( {c}^{′} - b ) \qquad ( 2 )$$

The image IM3, the image IM4, and the image IM5, which are the second learning images illustrated in FIG. 3, are generated by executing the above-described transformation processing on each of the plurality of different teacher transformation vectors wₜⁱ′. Note that the plurality of teacher transformation vectors wₜⁱ′ herein are generated so as to have a probability distribution of generation matching a probability distribution in a distribution range D of a sample group of the first learning images. Therefore, as illustrated in FIG. 3, the learning data generation unit 26 generates the plurality of second learning images IM3, IM4, and IM5 within the distribution range D on the color space of the sample group of the plurality of first learning images. Specifically, as illustrated in FIG. 3, the second learning image IM3 is generated by changing a color of the corrected image IM2 using a teacher transformation vector wₜ¹′, and the second learning image IM5 is generated by changing a color of the corrected image IM2 using a teacher transformation vector wₜ²′. As a result, the plurality of second learning images IM3, IM4, and IM5 similar to color variations of actual images captured under various light sources are generated. Each of the plurality of second learning images IM3, IM4, and IM5 is a pseudo image and can be used as learning data as described later.

Note that the teacher transformation vector wₜ¹′ is also an encoding correction coefficient vector for transforming the color of the second learning image IM3 into the color of the corrected image IM2. Similarly, the teacher transformation vector wₜ²′ is also an encoding correction coefficient vector for transforming the color of the second learning image IM5 into the color of the corrected image IM2. Therefore, a pair of each of the plurality of second learning images and each of the plurality of teacher transformation vectors wₜⁱ′ is used as second learning data as described later. In addition, a pair of each of the plurality of first learning images and each of the plurality of encoding correction coefficient vectors w′ is used as first learning data as described later.

Therefore, in order to simplify the description, hereinafter, the encoding correction coefficient vector w′ used to transform a color of the first learning image into a color of a corrected image is also simply referred to as a first correction coefficient, and a teacher transformation vector wₜ′ used to transform a color of the second learning image into a color of a corrected image is also simply referred to as a second correction coefficient.

The learning data generation unit 26 generates the first learning data in which the first learning image and the first correction coefficient are associated with each other for each of the plurality of first learning images. In addition, the learning data generation unit 26 generates the second learning data in which the second learning image and the second correction coefficient are associated with each other for each of the plurality of second learning images. The first correction coefficient and the second correction coefficient are values calculated in advance and are also teacher data.

The learning data storage unit 28 stores the first learning data and the second learning data generated by the learning data generation unit 26.

The trained model generation unit 30 generates a trained model that outputs a correction coefficient for correcting a color of an image in which a tongue appears in response to an input of the image using a known machine learning algorithm based on the first learning data and the second learning data stored in the learning data storage unit 28. Note that the trained model is, for example, a known neural network model. For generating the trained model, learning is performed so as to minimize an error between the correction coefficient output from the model and teacher data of the correction coefficient.

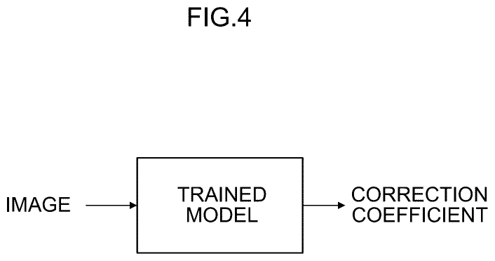

FIG. 4 is a view for describing the trained model of the present embodiment. As illustrated in FIG. 4, when an image in which a tongue appears is input to the trained model of the present embodiment, a correction coefficient for correcting a color of the image is output.

The trained model generated by the trained model generation unit 30 is stored in the trained model storage unit 32.

The acquisition unit 34 acquires the image in which the tongue appears as a target. This image is an image different from the first learning image and the second learning image, and is an image which is a target to be subjected to color correction.

The correction unit 36 acquires the correction coefficient output from the trained model when the image acquired by the acquisition unit 34 is input to the trained model stored in the trained model storage unit 32. The correction unit 36 corrects the color of the image using the correction coefficient.

The output unit 38 outputs the image whose color has been corrected by the correction unit 36 as a result.

A user who operates the information processing device 10 confirms the output result and confirms a color of the tongue appearing in the image.

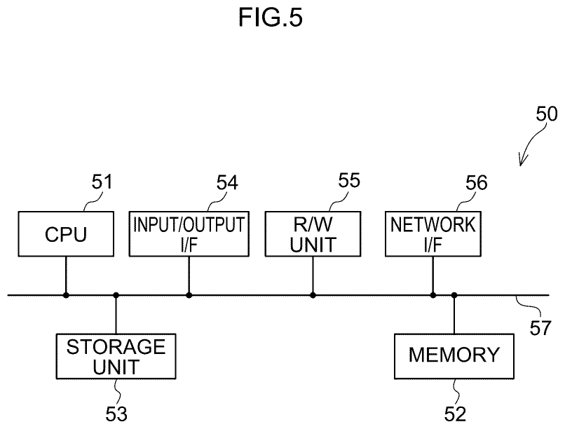

The information processing device 10 can be implemented by, for example, a computer 50 illustrated in FIG. 5. The computer 50 includes a CPU 51, a memory 52 as a temporary storage area, and a non-volatile storage unit 53. The computer 50 further includes an input/output interface (I/F) 54 to which an external device, an output device, and the like are connected, and a read/write (R/W) unit 55 which controls reading and writing of data with respect to a recording medium. The computer 50 further includes a network I/F 56 connected to a network such as the Internet. The CPU 51, the memory 52, the storage unit 53, the input/output I/F 54, the R/W unit 55, and the network I/F 56 are connected to each other via a bus 57.

The storage unit 53 can be implemented by a hard disk drive (HDD), a solid state drive (SSD), a flash memory, or the like. The storage unit 53 as a storage medium stores a program for causing the computer 50 to function. The CPU 51 reads the program from the storage unit 53, develops the program in the memory 52, and sequentially executes processes included in the program.

### [Operation of Information Processing Device of Embodiment]

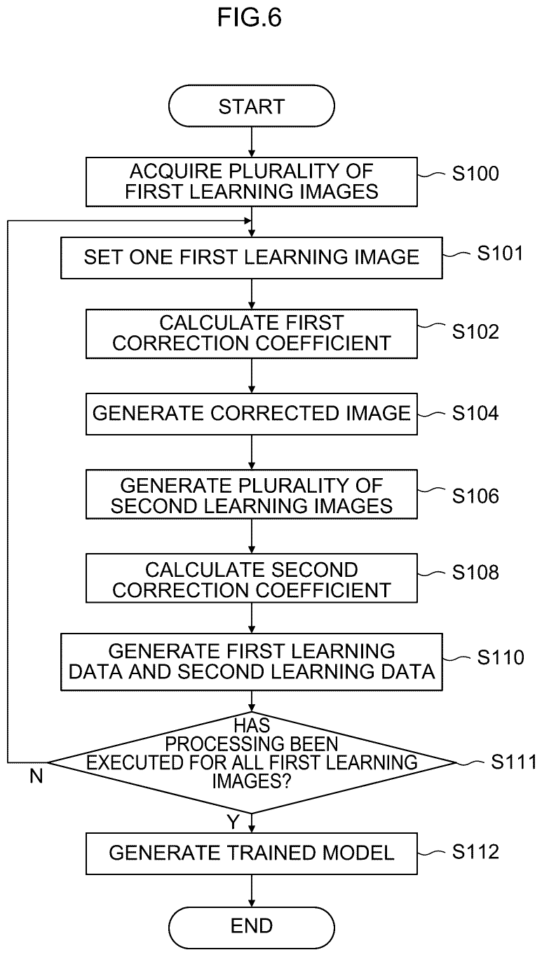

Next, a specific operation of the information processing device 10 of the embodiment will be described. The information processing device 10 executes trained model generation processing illustrated in FIG. 6.

First, in step S100, the learning acquisition unit 22 reads a plurality of first learning images stored in the data storage unit 20 to acquire the plurality of first learning images.

In step S101, the calculation unit 24 sets one first learning image among the plurality of first learning images acquired in step S100.

Next, in step S102, the calculation unit 24 uses a known method to calculate a first correction coefficient for correcting a color appearing in a color chart in the first learning image set in step S101 to a reference color as a reference.

In step S104, the learning data generation unit 26 corrects the color of the first learning image using the first correction coefficient calculated in step S102 to generate a corrected image.

In step S106, the learning data generation unit 26 changes a color of each pixel of the corrected image generated in step S104 to generate a plurality of second learning images.

In step S108, for each of the plurality of second learning images generated in step S106, the learning data generation unit 26 calculates a second correction coefficient for correcting a color of the second learning image to a color of a corrected image.

In step S110, the learning data generation unit 26 generates first learning data in which an image of a tongue portion in the first learning image set in step S101 is associated with the first correction coefficient calculated in step S102. In step S110, for each of the plurality of second learning images generated in step S106, the learning data generation unit 26 generates second learning data in which an image of a tongue portion in the second learning image is associated with the second correction coefficient calculated in step S108. The learning data generation unit 26 stores the first learning data and the second learning data in the learning data storage unit 28.

In step S112, the learning data generation unit 26 determines whether or not each process of steps S101 to S110 has been executed for all the first learning images stored in the data storage unit 20. In a case in which each process of steps S101 to S110 has been executed for all the first learning images stored in the data storage unit 20, the processing proceeds to step S112. In a case in which the first learning image for which each process of steps S101 to S110 has not been executed remains, the processing returns to step S101.

In step S112, the trained model generation unit 30 generates a trained model that outputs a correction coefficient for correcting a color of an image in which a tongue appears in response to an input of the image using a known machine learning algorithm based on a plurality of pieces of the first learning data and a plurality of pieces of the second learning data stored in the learning data storage unit 28. The trained model generation unit 30 stores the generated trained model in the trained model storage unit 32.

When the trained model generation processing in FIG. 6 is executed, a trained model that outputs a correction coefficient for correcting a color of an image in which a tongue appears in response to an input of the image is generated, and a color of an image of the tongue can be corrected using the correction coefficient output from the trained model.

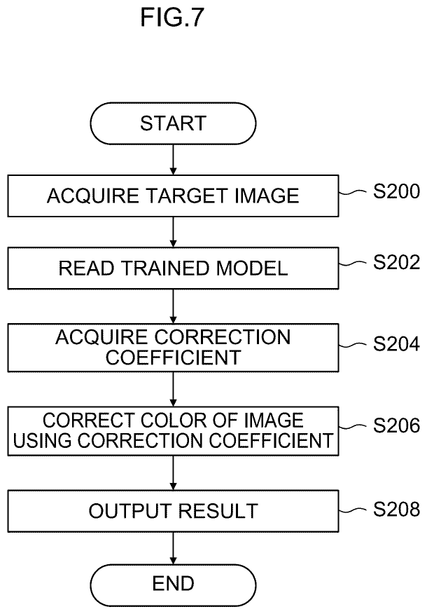

Next, when receiving a predetermined instruction signal, the information processing device 10 executes information processing illustrated in FIG. 7.

In step S200, the acquisition unit 34 acquires an image in which a tongue appears as a target.

In step S202, the correction unit 36 reads a trained model from the trained model storage unit 32.

In step S204, the correction unit 36 inputs the image acquired in step S200 to the trained model read in step S202 to acquire a correction coefficient output from the trained model.

In step S206, the correction unit 36 corrects a color of the image acquired in step S200 using the correction coefficient acquired in step S204.

In step S208, the output unit 38 outputs the image whose color has been corrected in step S206 as a result.

As described above, the information processing device 10 of the embodiment acquires a learning image in which a tongue for learning and a color chart appear. Then, the information processing device 10 calculates a correction coefficient for correcting a color appearing in the color chart in the learning image to a reference color as a reference. The information processing device 10 generates learning data in which an image of a tongue portion for learning in the learning image is associated with the correction coefficient. The information processing device 10 generates a trained model that outputs a correction coefficient for correcting a color of an image in which a tongue appears in response to an input of the image based on the learning data. As a result, it is possible to acquire the correction coefficient for performing color correction similar to the color correction method using the color chart without capturing an image of the color chart together with the tongue. In addition, the color of the image in which the tongue appears can be corrected using the correction coefficient, whereby the color correction similar to the color correction method using the color chart can be performed without capturing the image of the color chart together with the tongue.

In addition, the information processing device 10 generates second learning data and generates the trained model based on the second learning data, thereby being able to obtain the correction coefficient for more accurately correcting the color of the image. Specifically, since the number of pieces of learning data increases, the trained model is appropriately trained. Furthermore, a plurality of second learning images are generated so as to fall within a distribution range of each pixel value of a plurality of first learning images, the plurality of second learning images similar to color variations of actual images captured under various light sources are generated.

Note that the technique of the disclosure is not limited to the above embodiment, and various modifications and applications can be made without departing from the gist of the disclosure.

For example, the embodiment in which the program is installed in advance has been described in the present specification, but the program can be provided by being stored in a computer-readable recording medium.

Note that the processing executed by the CPU reading software (the program) in the above embodiment may be executed by various processors other than the CPU. Examples of the processors in this case include a programmable logic device (PLD) whose circuit configuration can be changed after manufacturing, such as a field-programmable gate array (FPGA), a dedicated electric circuit that is a processor having a circuit configuration exclusively designed for executing specific processing, such as an application specific integrated circuit (ASIC), and the like. Alternatively, a general-purpose graphics processing unit (GPGPU) may be used as the processor. In addition, each processing may be executed by one of the various processors, or may be executed by any combination of two or more processors of the same type or different types (for example, a plurality of FPGAs, a combination of a CPU and an FPGA, and the like). In addition, more specifically, a hardware structure of the various processors is an electric circuit in which circuit elements such as semiconductor elements are combined.

Although an aspect in which the program is stored (installed) in advance in a storage has been described in the above embodiment, but the invention is not limited thereto. The program may be provided in a form of being stored in a non-transitory storage medium such as a compact disk read only memory (CD-ROM), a digital versatile disk read only memory (DVD-ROM), or a universal serial bus (USB) memory. In addition, the program may be downloaded from an external device via a network.

In addition, each processing of the present embodiment may be configured by a computer, a server, or the like including a general-purpose arithmetic processing device, a storage device, and the like, and each processing may be executed by a program. This program is stored in the storage device, and can be recorded in a recording medium such as a magnetic disk, an optical disk, or a semiconductor memory, or can be provided through a network. Of course, any other constituent elements are not necessarily implemented by a single computer or server, and may be implemented in a distributed manner by a plurality of computers connected through a network.

In addition, the case in which the subject is a human tongue has been described as an example in the above embodiment, but the invention is not limited thereto. The subject may be anything. For example, the present embodiment can be applied even when the subject is a human face, a biological tissue, a landscape, or the like.

For example, the following modifications are conceivable regarding the subject.

### First Modification

For example, each exposed part of a human body (for example, skin, an eye, lips, hair, or the like exposed to the outside of the human body) may be set as a subject. For example, in a case in which the subject is skin, a color of the skin can be corrected, and how the skin looks under a light environment as a reference can be reproduced. More specifically, for example, in a case in which an image of skin wearing makeup is captured under a certain light environment, it is possible to reproduce how the skin looks under the light environment as the reference. In addition, in a case in which the color of the skin under the light environment as the reference is specified, it is possible to reproduce what color the skin looks like under various light environments. Therefore, the technique of the present embodiment can also be a useful technique, for example, for evaluating a cosmetic product applied to the skin.

Similarly, in a case in which an eye is set as the subject, for example, it is possible to reproduce a color of the eye under a light environment as a reference when a color contact lens is worn. Similarly, in a case in which the color of the eye under the light environment as the reference is specified, it is possible to reproduce what color the eye looks like under various light environments. Therefore, the technique of the present embodiment can also be a useful technique, for example, for evaluating the color contact lens.

Similarly, in a case in which the lips are set as the subject, it is possible to reproduce a color of the lips under a light environment as a reference when a lipstick is applied to the lips, for example. Similarly, in a case in which the color of the lips under the light environment as the reference is specified, it is possible to reproduce what color the lips look like under various light environments. Therefore, the technique of the present embodiment can also be a useful technique, for example, for evaluating the lipstick.

Similarly, in a case in which hair is set as the subject, it is possible to reproduce a color of the hair under a light environment as a reference when the hair is dyed, for example. Similarly, in a case in which the color of the hair under the light environment as the reference is specified, it is possible to reproduce what color the hair looks like under various light environments. Therefore, the technique of the present embodiment can also be a useful technique, for example, for evaluating a technique for technique hair.

As described above, when a beauty product or service is evaluated, a color of the subject under a specific light environment (for example, under a light environment in a beauty facility) is often different from a color of the subject under a light environment different from the specific light environment (for example, under a light environment in the outdoors, an office, a hotel, a restaurant, or the like). In such a case, although appearance is good under the specific light environment (for example, a beauty facility), the appearance is not good under an actual light environment (for example, the outdoors or the like) in some cases. Therefore, for example, the color of the subject obtained under the specific light environment (for example, a beauty facility) is once corrected to a color under the light environment as the reference, and then transformed to colors under various light environments using the technique of the present embodiment, whereby it is possible to evaluate the beauty product or service. Note that a known technique can be adopted for transformation processing from a color under the light environment as the reference to colors under various light environments.

### Second Modification

Alternatively, for example, an unexposed portion of a human body (for example, various biological tissues which are not exposed to the outside of the human body) may be set as a subject. For example, the subject may be a tooth, a gingiva, a chin (uvula), an organ, a blood vessel wall, an airway wall, an intestinal tract wall, an ear cavity wall, a nasal cavity wall, an inner vaginal wall, an inner uterine wall, or the like.

In this case, a color of the subject under a light environment as a reference is specified by correcting colors of the subject captured by various capturing devices, and becomes useful information for performing various medical practices. Therefore, the technique of the present embodiment can also be a useful technique for performing a medical practice.

### Third Modification

Alternatively, for example, various products may be set as a subject. For example, a color in a light source environment such as a factory or a test production room where a craft product is manufactured is often different from a color under a light environment when the craft product is actually used. In such a case, although appearance is good under a specific light environment (for example, a factory or the like), the appearance is not good under an actual light environment in some cases. Therefore, for example, colors of various products such as a craft product obtained under a specific light environment (for example, a factory or the like) are once corrected to colors under a light environment as a reference, and then transformed to colors under various light environments using the technique of the present embodiment, whereby the colors of various products such as a craft product can be evaluated.

### Fourth Modification

Alternatively, for example, various foods (for example, meat, fish, vegetables, fruits, or the like) may be used as a subject. For example, colors of various foods under a specific light source environment are often different from colors of the various foods under a light environment when actually displayed. Therefore, for example, the colors of various foods obtained under the specific light environment is once corrected to colors under a light environment as a reference, and then transformed to colors under various light environments using the technique of the present embodiment, whereby it is possible to evaluate the colors of various foods (or evaluate freshness).

### Fifth Modification

Alternatively, for example, a group may be generated for each combination of a light environment in which a subject is placed and an imaging device (more specifically, various setting values of the imaging device) that captures the subject, and a trained model may be generated for each group. In general, how an original color of the subject changes is determined by the combination of the light environment and the imaging device. Examples of what defines the light environment include a type of a light source. In addition, as what defines the imaging device, characteristics of an image sensor included in the imaging device, color temperature transformation setting by terminal software, and the like are assumed. Therefore, a group is generated for each combination of the light environment in which the subject is placed and the imaging device that captures the subject, learning data is amplified so as to reproduce a variation in a color change for each group, and the trained model that outputs a correction coefficient is generated for each group. As a result, it is possible to obtain the trained model for outputting the correction coefficient according to the combination of the light environment in which the subject is placed and the imaging device that captures the subject. As a result, for example, a trained model for obtaining a correction coefficient for outdoor image capturing, a trained model for obtaining a correction coefficient for indoor image capturing, a trained model for outputting a correction coefficient for in-vivo tissue image capturing, and the like can be individually generated.

For example, in a case in which an endoscopic image or the like is a target, a dedicated light source and a dedicated imaging device are assumed. Therefore, a trained model specialized in outputting a correction coefficient for correcting a color of an endoscopic image is obtained by amplifying an image sample group of endoscopic images and generating the trained model based on the image sample group, and the color of the endoscopic image can be more appropriately corrected. Note that, when the image sample group of the endoscopic image is amplified, as described above, the images are generated so as to have a probability distribution matching a distribution in a space of the correction coefficients for the entire image sample group.

In addition, as grouping depending on characteristics of the light sources, for example, an image sample group specialized for an indoor portrait, an image sample group specialized for an outdoor scene under natural light, or the like can be used to generate a trained model specialized for each, and a color of each image can be more appropriately corrected.

In addition, the case in which the information processing device 10 executes the trained model generation processing in FIG. 6 and the information processing in FIG. 7 has been described as an example in the above embodiment, but the invention is not limited thereto. For example, a trained model generation device may execute the trained model generation processing in FIG. 6, and an information processing device may execute the information processing in FIG. 7. In this case, the trained model generation device includes at least the learning acquisition unit 22, the calculation unit 24, the learning data generation unit 26, and the trained model generation unit 30. In addition, in this case, the information processing device includes at least the acquisition unit 34 and the correction unit 36.

All cited documents, patent applications, and technical standards mentioned in the present specification are incorporated by reference in the present specification to the same extent as if the individual cited document, patent application, or technical standard was specifically and individually indicated to be incorporated by reference.

### SUPPLEMENTARY NOTES

Aspects of the disclosure will be added hereinafter.

### Supplementary Note 1

A trained model generation device including:
a learning acquisition unit that acquires a learning image in which a subject for learning and a color chart appear;
a calculation unit that calculates a correction coefficient for correcting a color appearing in the color chart in the learning image to a reference color as a reference;
a learning data generation unit that generates learning data in which an image of a portion of the subject for learning in the learning image is associated with the correction coefficient; and
a trained model generation unit that generates a trained model that outputs a correction coefficient for correcting a color of an image in which a subject appears in response to an input of the image based on the learning data.

### Supplementary Note 2

The trained model generation device according to Supplementary Note 1, wherein
the learning image is a first learning image,
the correction coefficient is a first correction coefficient,
the learning data is first learning data,
the learning data generation unit
corrects the color of the image of the portion of the subject for learning in the first learning image using the first correction coefficient to generate a corrected image,
changes a color of the corrected image to generate a plurality of second learning images,
calculates, for each of the plurality of second learning images, a second correction coefficient for correcting a color of the second learning image to a color of the corrected image, and generates second learning data in which the second learning image is associated with the second correction coefficient, and
generates the trained model based on the first learning data and the second learning data.

### Supplementary Note 3

The trained model generation device according to Supplementary Note 1 or 2, wherein
the learning data generation unit generates a plurality of second learning images to fall within a distribution range of each pixel value of a plurality of first learning images.

### Supplementary Note 4

An information processing device including:
an acquisition unit that acquires an image in which a subject appears as a target; and
a correction unit that inputs the image acquired by the acquisition unit to a trained model generated in advance to acquire a correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
the correction coefficient for learning is a correction coefficient for correcting a color appearing in a color chart in a learning image in which a subject for learning and the color chart appear to a reference color as a reference.

### Supplementary Note 5

A trained model generation method causing a computer to execute processing, the processing including:
acquiring a learning image in which a subject for learning and a color chart appear;
calculating a correction coefficient for correcting a color appearing in the color chart in the learning image to a reference color as a reference;
generating learning data in which an image of a portion of the subject for learning in the learning image is associated with the correction coefficient; and
generating a trained model that outputs a correction coefficient for correcting a color of an image in which a subject appears in response to an input of the image based on the learning data.

### Supplementary Note 6

An information processing method causing a computer to execute processing, the processing including:
acquiring an image in which a subject appears as a target; and
inputting the acquired image to a trained model generated in advance to acquire a correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
the correction coefficient for learning is a correction coefficient for correcting a color appearing in a color chart in a learning image in which a subject for learning and the color chart appear to a reference color as a reference.

### Supplementary Note 7

A trained model generation program for causing a computer to execute processing, the processing including:
acquiring a learning image in which a subject for learning and a color chart appear;
calculating a correction coefficient for correcting a color appearing in the color chart in the learning image to a reference color as a reference;
generating learning data in which an image of a portion of the subject for learning in the learning image is associated with the correction coefficient; and
generating a trained model that outputs a correction coefficient for correcting a color of an image in which a subject appears in response to an input of the image based on the learning data.

### Supplementary Note 8

An information processing program for causing a computer to execute processing, the processing including:
acquiring an image in which a subject appears as a target; and
inputting the acquired image to a trained model generated by the trained model generation program according to Supplementary Note 7 to acquire the correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
the correction coefficient for learning is a correction coefficient for correcting a color appearing in a color chart in a learning image in which a subject for learning and the color chart appear to a reference color as a reference.

What is claimed is:

1. A trained model generation device comprising: a memory; and a processor connected to the memory,
wherein the processor is configured to:
acquire a learning image in which a subject for learning and a color chart appear;
calculate a correction coefficient for correcting a color appearing in the color chart in the learning image, to a reference color as a reference;
generate learning data in which an image of a portion of the subject for learning in the learning image is associated with the correction coefficient; and
generate a trained model that outputs a correction coefficient for correcting a color of an image in which a subject appears in response to an input of the image, based on the learning data.

2. The trained model generation device according to claim 1, wherein:
the learning image is a first learning image,
the correction coefficient is a first correction coefficient,
the learning data is first learning data, and
the processor is configured to:
correct the color of the image of the portion of the subject for learning in the first learning image using the first correction coefficient to generate a corrected image;
change a color of the corrected image to generate a plurality of second learning images;
calculate, for each of the plurality of second learning images, a second correction coefficient for correcting a color of the second learning image to a color of the corrected image, and generate second learning data in which the second learning image is associated with the second correction coefficient; and
generate the trained model based on the first learning data and the second learning data.

3. The trained model generation device according to claim 1, wherein
the processor is configured to generate a plurality of second learning images to fall within a distribution range of each pixel value of a plurality of first learning images.

4. An information processing device comprising: a memory; and a processor connected to the memory,
wherein the processor is configured to:
acquire an image in which a subject appears as a target; and
input the acquired image to a trained model generated in advance, to acquire a correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
wherein the correction coefficient for learning is a correction coefficient for correcting a color appearing in a color chart in a learning image in which the subject for learning and the color chart appear, to a reference color as a reference.

5. A trained model generation method comprising:
acquiring, by a processor, a learning image in which a subject for learning and a color chart appear;
calculating, by the processor, a correction coefficient for correcting a color appearing in the color chart in the learning image, to a reference color as a reference;
generating, by the processor, learning data in which an image of a portion of the subject for learning in the learning image is associated with the correction coefficient; and
generating, by the processor, a trained model that outputs a correction coefficient for correcting a color of an image in which a subject appears in response to an input of the image, based on the learning data.

6. An information processing method comprising:
acquiring, by a processor, an image in which a subject appears as a target; and
inputting, by the processor, the acquired image to a trained model generated in advance, to acquire a correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
wherein the correction coefficient for learning is a correction coefficient for correcting a color appearing in a color chart in a learning image in which the subject for learning and the color chart appear, to a reference color as a reference.

7. A non-transitory recording medium in which a trained model generation program is recorded, the trained model generation program being executable by a processor to perform processing comprising:
acquiring a learning image in which a subject for learning and a color chart appear;
calculating a correction coefficient for correcting a color appearing in the color chart in the learning image, to a reference color as a reference;
generating learning data in which an image of a portion of the subject for learning in the learning image is associated with the correction coefficient; and
generating a trained model that outputs a correction coefficient for correcting a color of an image in which a subject appears in response to an input of the image, based on the learning data.

8. A non-transitory recording medium in which an information processing program is recorded, the information processing program being executable by a processor to perform processing comprising:
acquiring an image in which a subject appears as a target; and
inputting the acquired image to a trained model generated in advance, to acquire a correction coefficient output from the trained model and correct a color of the image using the correction coefficient,
wherein the trained model is a trained model that outputs a correction coefficient for correcting a color of an image in which a subject appears in response to an input of the image, the trained model being trained in advance based on learning data in which a subject for learning is associated with the correction coefficient for learning, and
wherein the correction coefficient for learning is a correction coefficient for correcting a color appearing in a color chart in a learning image in which the subject for learning and the color chart appear, to a reference color as a reference.
